(19) United States
(12) Patent Application Publication
(10) Pub. No.: US 2025/0255776 A1
(43) Pub. Date: Aug. 14, 2025

(54) MASSAGER DRIVING ASSEMBLY AND MASSAGER

(71) Applicant: Dongguan Dibe Electronic Technology Co. Ltd, Dongguan (CN)

(72) Inventor: Sikun WU, Dongguan (CN)

(21) Appl. No.: 18/740,450

(22) Filed: Jun. 11, 2024

(30) Foreign Application Priority Data
Feb. 9, 2024 (CN) 202420290832.0

(51) Int. Cl. A61H 23/02

(52) U.S. Cl. CPC A61H 23/0254; A61H 2201/1215; A61H 2201/14

(57) ABSTRACT

A massager driving assembly includes a base; a rotating motor having a rotating shaft; and a driving disk arranged in the base and fixedly connected to the rotating shaft. A non-circular curved groove shaped like a closed ring and a swing hole arranged eccentrically with respect to the rotating shaft are formed in the driving disk. A clamping piece capable of swinging back and forth unidirectionally is arranged on the base, the bottom of the clamping piece is slidably inserted into the curved groove, a swing column capable of swinging omni-directionally is arranged on the base, the bottom of the swing column is inserted into the swing hole, and a swing center of the swing column is located on an axis of the rotating shaft. When rotating, the driving disk drives the clamping piece to swing unidirectionally and drives the swing column to swing omni-directionally.

### FIELD

The application belongs to the technical field of massagers, and more particularly relates to a massager driving assembly and a massager.

### BACKGROUND

Only a small percentage of massagers on the market has both the swinging function and the clamping function to provide comfortable usage experience for users. However, such massagers in related arts have a complex driving structure, which leads to a complex assembly structure of components and inconvenience in assembly, thus increasing manufacturing and assembly costs.

### SUMMARY

The objective of the embodiments of the application is to provide a massager driving assembly and a massager to solve the technical problem of complex assembly structure in the prior art.

In one aspect, the present application provides a massager driving assembly which comprises a base defining an axis; a rotating motor fixedly arranged on the base and having a rotating shaft parallel to the axis of the base; and a driving disk arranged in the base and fixedly connected to the rotating shaft, a non-circular curved groove which has a closed-ring shape and a swing hole which is arranged eccentrically with respect to the rotating shaft being formed in an end surface of the driving disk. A clamping piece capable of swinging back and forth unidirectionally is arranged on the base, a bottom of the clamping piece is slidably inserted into the curved groove, a swing column capable of swinging omni-directionally is arranged on the base, a bottom of the swing column is inserted into the swing hole, and a swing center of the swing column is located on an axis of the rotating shaft. When rotating, the driving disk drives the clamping piece to swing unidirectionally and drives the swing column to swing omni-directionally.

In some embodiments, a vibration motor is arranged at a top end of the swing column.

In some embodiments, the base, the clamping piece and the swing column are all made of plastic material.

In some embodiments, two said clamping pieces are symmetrically arranged on the base.

In some embodiments, a receiving cavity is formed in the base, and the driving disk is arranged in the receiving cavity.

In some embodiments, the base comprises a first portion and a second portion which are detachable from each other, the receiving cavity is formed between the first portion and the second portion, and the clamping piece and the swing column are arranged on the first portion.

In some embodiments, the curved groove is elliptic.

In some embodiments, a swing cavity is formed in the base, the swing column comprises a spherical rotating portion rotatably arranged in the swing cavity and an insertion bar inserted into the swing hole, and a top and a bottom of the swing cavity are open to allow the insertion bar to pass through the swing cavity to be inserted into the swing hole.

In some embodiments, a plurality of stop blocks are arranged on an inner wall of the swing cavity in a circumferential direction of the swing cavity, are surfaces are arranged on sides, facing an axis of the swing cavity, of the stop blocks, every two adjacent said stop blocks are arranged alternately in the circumferential direction and are symmetric in an axial direction, and the stop blocks cooperatively form a swing space for preventing the rotating portion from moving in the axial direction.

In some embodiments, the base defines two first assembly slots which are symmetrically located at opposite sides of the swing cavity, each of the first assembly slots extends in an axial direction of the swing cavity, and tops of the first assembly slots are open; and limit columns are symmetrically arranged on opposite sides of the rotating portion and inserted into the first assembly slots respectively.

In some embodiments, second assembly slots and first assembly holes are formed in the base, the second assembly slots are arranged in an axial direction, tops of the second assembly slots are open, and the first assembly holes are formed in bottoms of the second assembly slots; rotating posts are arranged on two sides of a bottom of the clamping piece, and the rotating posts are able to slide along the second assembly slots to be inserted into the first assembly holes.

In a second aspect, the present application provides a massager which comprises the massager driving assembly described above, a housing having a top formed with an opening, and an elastic core. The massager driving assembly is arranged in the housing, the core has a U-shaped cross-section parallel to an axial direction thereof and is arranged in the opening of the housing, and the clamping piece and the swing column are used for driving the core to swing and contract for clamping or expand.

The massager driving assembly and the massager provided by the embodiments of the application have at least the following beneficial effects:

A driving disk is arranged, and a non-circular curved groove which is shaped like a closed ring and a swing hole which is arranged eccentrically are formed in the driving disk, such that the driving disk, when rotating, can drive a clamping piece to swing back and forth and synchronously drive a swing column to swing omni-directionally to thereby drive the core of the massager to move in multiple directions. The structure of the massager driving assembly is simple, assembly of the massager driving assembly is easy, and the production cost can be effectively reduced under precondition of satisfying multi-dimensional usage requirements of users.

### BRIEF DESCRIPTION OF THE DRAWINGS

To better clarify the technical solutions of the embodiments of the application, drawings used for describing the embodiments of the application or the prior art are briefly introduced below. Obviously, the drawings in the following description merely illustrate some embodiments of the application, and those ordinarily skilled in the art can obtain other drawings according to the following ones without creative labor.

FIG. 1 is a perspective view of a massager according to some embodiments of the application, a housing and a core of the massager being removed for clearly showing a massager driving assembly of the massager;

FIG. 2 is a front view of the massager according to some embodiments of the application;

FIG. 3 is a perspective sectional view of the massager according to some embodiments of the application;

FIG. 4 is a sectional view of the massager according to some embodiments of the application;

FIG. 5 is a perspective view of a first portion according to some embodiments of the application;

FIG. 6 is a partial perspective sectional view of the first portion according to some embodiments of the application;

FIG. 7 is a perspective view of a driving disk according to some embodiments of the application;

FIG. 8 illustrates the massager with the housing and the core shown.

### DESCRIPTION OF THE EMBODIMENTS

To gain a better understanding of the technical issues to be settled by the application and the technical solutions and beneficial effects of the application, the application is described in further detail below in conjunction with accompanying drawings and embodiments.

It should be understood that the specific embodiments described here are merely used for explaining the application, and are not used for limiting the application.

It should be noted that when one element is referred to as being “fixed to” or “arranged on” the other element, it may be directly or indirectly connected to the other element.

When one element is referred to as being “connected to” the other element, it may be directly or indirectly connected to the other element.

It should be understood that terms such as “length”, “width”, “upper”, “lower”, “front”, “back”, “left”, “right”, “vertical”, “horizontal”, “top”, “bottom”, “inner” and “outer” are used to indicate directional or positional relations based on the accompanying drawings merely for the purpose of facilitating and simplifying the description of the application, do not indicate or imply that devices or elements referred to must be in a specific direction, or be configured and operated in a specific direction, and thus should not be construed as limitations of the application.

In addition, terms “first” and “second” are merely for the purpose of description, and should not be construed as indicating or implying relative importance or implicitly indicating the number of technical features referred to. Therefore, a feature defined by “first” or “second” may explicitly or implicitly indicate the inclusion of one or more said features.

In the description of the application, “multiple” refers to two or more, unless otherwise expressly and specifically defined.

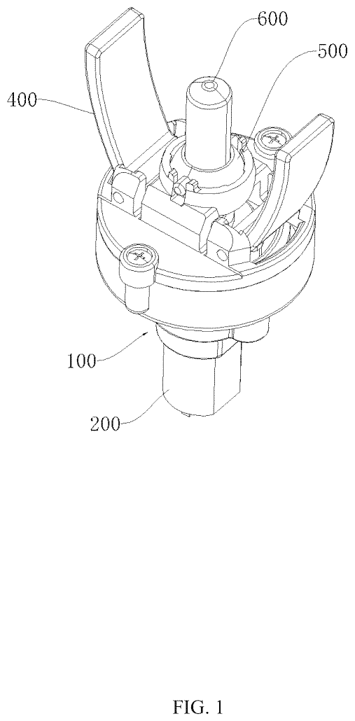

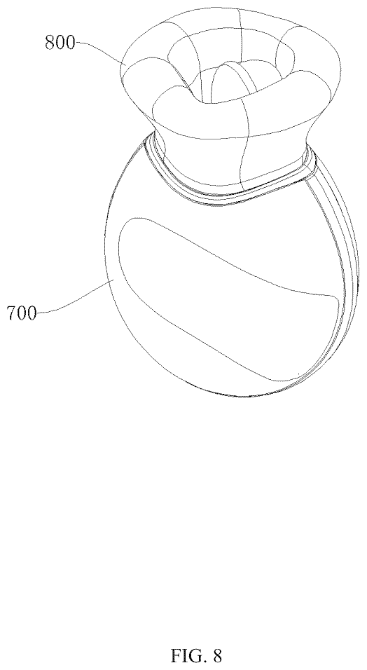

Referring to FIGS. 1-8, a massager driving assembly and a massager provided by the embodiments of the application are described below.

It can be understood that the massager driving assembly provided by the embodiments of the application is assembled on a massager. The massager specifically comprises the massager driving assembly, a housing 700 and a core 800. The massager driving assembly is mounted in the housing 700, and the core 800 has a U-shaped cross-section parallel to an axial direction of the core 500. The core 800 is disposed around a clamping piece 400 and a swing column 500. The core 800 is elastic and is made of silicone or other elastic materials. When the clamping piece 400 and the swing column 500 rotate and swing, the core 800 is driven to rotate, swing, contract for clamping or expand to thereby provide multi-dimensional massage experience for users.

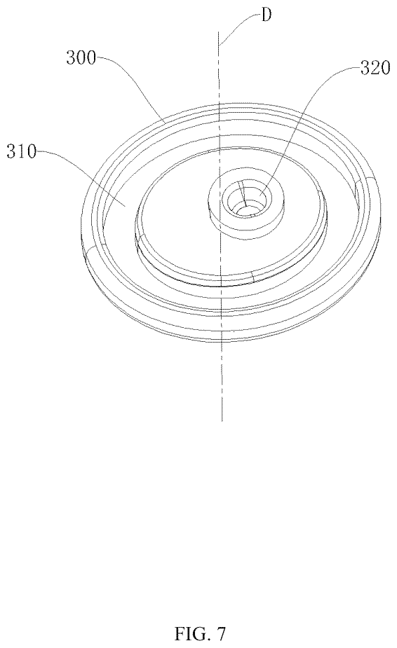

Referring to FIG. 1 and FIG. 7, the massager driving assembly provided by the application comprises a base 100, a rotating motor 200, a driving disk 300, a clamping piece 400 and a swing column 500.

The rotating motor 200 is fixedly mounted to the base 100, and an axis D of a rotating shaft of the rotating motor 200 is parallel to an axis of the base 100, for example, the axis D of the rotating shaft of the rotating motor 200 coincides with or is offset from the axis of the base 100. In this embodiment, the axis D of the rotating shaft coincides with the axis of the base 100 by way of example.

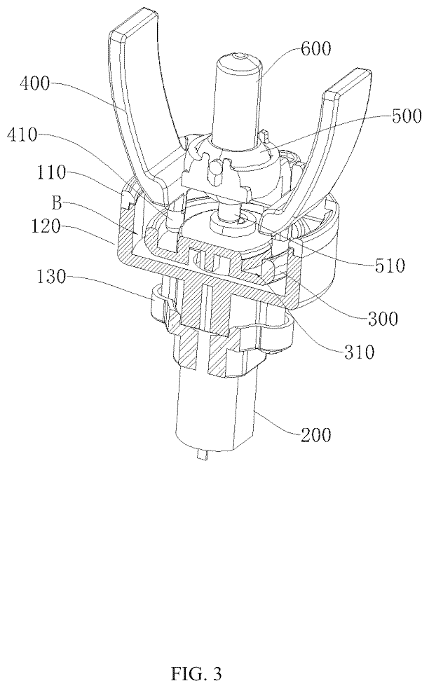

Referring to FIGS. 3, 4 and 7, the driving disk 300 is rotatably arranged in the base 100, and the bottom of the driving disk 300 is fixedly connected to the rotating shaft, that is, when rotating, the rotating motor 200 is capable of driving the driving disk 300 to rotate synchronously. A curved groove 310 and a swing hole 320 are formed in an upper surface of the driving disk 300. Specifically, the curved groove 310 has a closed-ring shape which is non-circular. For example, the curved groove 310 may be elliptic or in other irregular arc shapes. In this way, in a plane perpendicular to the axis of the base 100, when the driving disk 300 is driven by the rotating motor 200 to rotate, an intersection point between the curved groove 310 and the same radial connecting line taking a rotation center of the driving disk 300 as the center can change in real time to be located at different radial position (that is, the distance between the intersection point and the rotation center of the driving disk 300 is variable). The specific arrangement of the curved groove 310 is not limited to the arrangement described here.

Referring to FIGS. 1-4, the clamping piece 400 is arranged on the base 100 and is able to swing relative to the base 100 back and forth unidirectionally. Specifically, the middle of the clamping piece 400 is rotatably mounted to the base 100, and the bottom of the clamping piece 400 is slidably inserted into the curved groove 310. In this way, when the rotating disk 300 rotates, the radial position of the curved groove 310 in the circumferential direction will change; and because the middle of the clamping piece 400 is arranged rotatably and the bottom of the clamping piece 400 is inserted into the curved groove 310, the clamping piece 400 will be driven by the curved groove 310 to swing back and forth in the same radial direction.

Referring to FIGS. 1-4, the swing column 500 is arranged on the base 100 and is able to swing omni-directionally, the swing hole 320 is formed in the driving disk 300 and deviates from the axis D of the rotating shaft, the bottom of the swing column 500 is inserted into the swing hole 320, and a swing center of the swing column 500 is located on the rotating axis D of the driving motor. When the driving disk 300 rotates, the swing hole 320 in the driving disk 300 rotates continuously and eccentrically to drive the swing column 500 to swing continuously and omni-directionally.

In this way, the driving disk 300 can drive the clamping piece 400 to swing back and forth and drive the swing column 500 to swing omni-directionally, and a multi-stage transmission component is not needed; and when the driving assembly is assembled, a few parts are assembled, and the assembly process is simple and fast, thus greatly reducing manufacturing and assembly costs.

Referring to FIGS. 1-4, in some embodiments, a vibration motor 600 is arranged at a top end of the swing column 500. The vibration motor 600 may be a coreless motor. In this way, when the swing column 500 swings omni-directionally, the vibration motor 600 can vibrate synchronously to drive the core of the massager to vibrate to satisfy usage requirements of users.

In some embodiments, the base 100, the clamping piece 400 and the swing column 500 are all made of plastic materials. In this way, the base 100, the clamping piece 400 and the swing column 500 can deform elastically to some extent and can be squeezed to be assembled and limited during the assembly process.

Referring to FIGS. 1-4, in some embodiments, two clamping pieces 400 are symmetrically arranged on the base 100. In this way, when the driving disk 300 rotates, the two clamping pieces 400 can swing back and forth synchronously or alternately to provide a greater driving force for clamping deformation of the core of the massager to improve the massage experience of users.

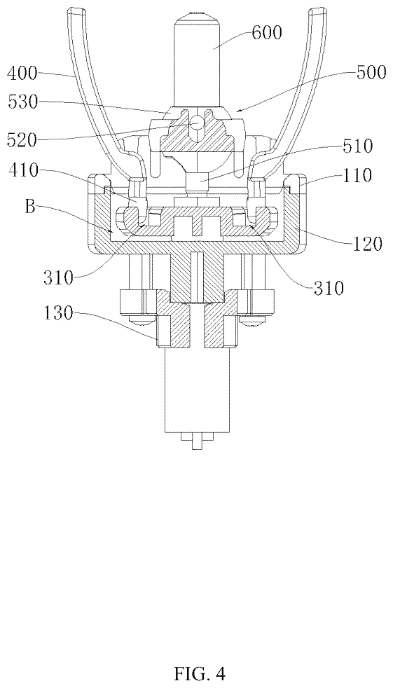

Referring to FIGS. 3-4, in some embodiments, a receiving cavity B is formed in the base 100, and the driving disk 300 is arranged in the receiving cavity B. In this way, the top structure of the driving assembly is simple to facilitate assembly, and movement interference with the driving disk 300 will not be caused after the core of the massager is disposed around the clamping piece 400 and the swing column 500, thus guaranteeing smooth rotation of the driving disk 300.

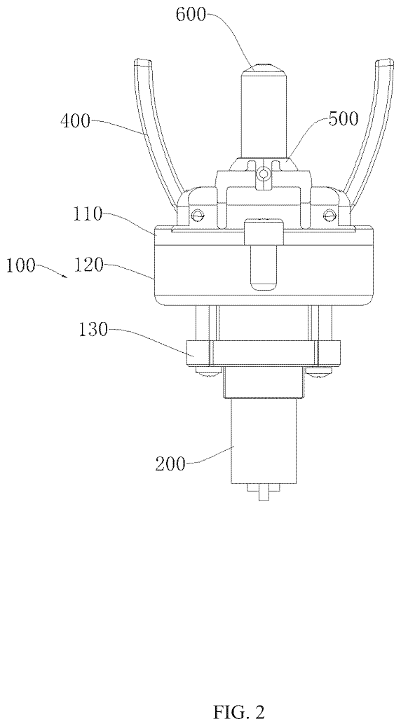

Referring to FIGS. 2-4, further, the base 100 at least comprises a first portion 110 and a second portion 120, the first portion 110 and the second portion 120 are detachable from each other. Cavities are formed in the first portion 110 and the second portion 120, and after the first portion 110 and the second portion 120 are assembled and combined together, the cavities of the first portion 110 and the second portion 120 cooperatively form the receiving cavity B for receiving the driving disk 300. The clamping pieces 400 and the swing column 500 are arranged on the first portion 110. In this way, the base 100 is easy and convenient to assemble.

Referring to FIGS. 2-4, it can be understood that, further, a third portion 130 is connected to the second portion 120, the rotating motor 200 is assembled on the second portion 120 and is fixed and limited by the third portion 130. The first portion 110, the second portion 120 and the third portion 130 are connected and fixed with fasteners, for examples: bolts.

Referring to FIG. 7, based on the above embodiments, the curved groove 310 is an elliptic groove. In this way, when the driving disk 300 rotates, the two clamping pieces 400 can move synchronously.

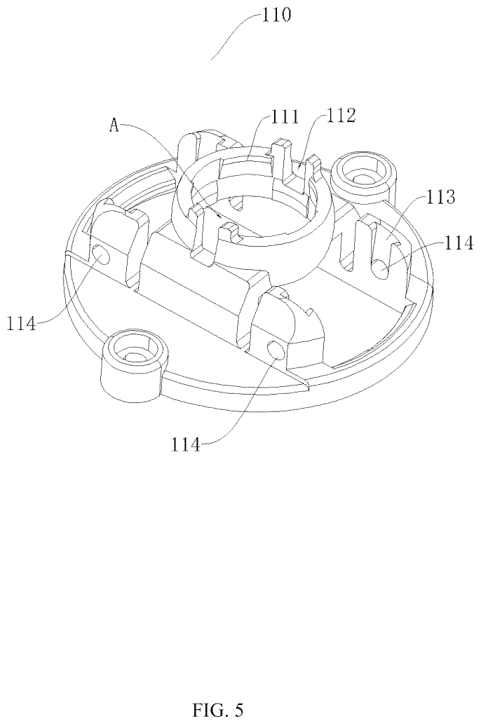

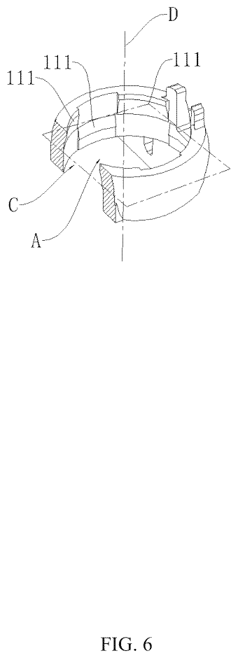

Referring to FIGS. 5-6, in some embodiments, a swing cavity A is formed in the base 100, and the swing column 500 comprises a spherical rotating portion 530 rotatably arranged in the swing cavity A and an insertion bar 510 inserted into the swing hole 320.

The swing cavity A has a variable diameter, the top and bottom of the swing cavity A are communicated with each other and open, a maximum diameter of the swing cavity A matches the diameter of the rotating portion 530, and a minimum diameter of the swing cavity A is less than the diameter of the rotating portion 530, such that the rotating portion 530 can be limited in the swing cavity A to be prevented from moving in the axial direction. In the embodiment where the base 100 comprises the first portion 110 and the second portion 120 which are detachable from each other, the swing cavity A is formed in the first portion 110. During assembly, after the swing column 500 passes through the swing cavity A, the rotating portion 530 of the swing column 500 squeezes the swing cavity A. Since the base 100 is made from plastic, that is, the wall of the swing cavity A can deform elastically, the rotating portion 530 can be squeezed into the swing cavity A, such that the swing column 500 is assembled.

Referring to FIGS. 5 and 6, in some embodiments, a plurality of stop blocks 111 are arranged on an inner surface of the wall of the swing cavity A in a circumferential direction. Arc surfaces are arranged on sides, facing an axis of the swing cavity A (the axis of the swing cavity A coincides with the axis D of the rotating shaft), of the stop blocks 111. It can be understood that, the arc surfaces are parts of a spherical surface, that is, the plurality of arc surfaces can be spliced to form a complete spherical surface.

Further, every two adjacent stop blocks 111 are arranged alternately in the circumferential direction, and are symmetric about a plane which is perpendicular to the axial direction. It should be understood that the plane about which the two adjacent stop blocks 111 are arranged axially and symmetrically is the plane where the maximum diameter of the swing cavity A is located (the plane is defined as a symmetry plane C). That is, the two adjacent stop blocks 111 are alternate in the circumferential direction and are not located at the same axial position, one of the stop blocks 111 is located above the symmetry plane C, the other stop block 111 is located below the symmetry plane C, and the orientations of the arc surfaces of the two adjacent stop blocks 111 are in opposite directions. For example, the arc surface of the stop block 111 located above the symmetry plane C faces downward while the arc surface of the stop block 111 located below the symmetry plane C faces upward.

In this way, a swing space for preventing the rotating portion 530 from moving upward and downward in the axial direction is defined by the stop blocks 111. During the rotating portion 530 is squeezed into the swing cavity A, a gap is reserved between any two stop blocks 111 located on the same side of the symmetry plane C, the gaps can reduce the thickness of the part of the wall of the swing cavity A such that the wall of the swing cavity has a small rigidity at the positions corresponding to the gaps and can easily deform elastically when the rotating portion 530 is squeezed. Thus, the rotating portion 530 can be pushed into or pulled out of the swing cavity A easily.

Referring to FIG. 5 and FIG. 6, in a further embodiment, first assembly slots 112 are symmetrically formed in the base 100 and located on opposite sides of the swing cavity A. The first assembly slots 112 extend in the axial direction, and tops of the first assembly slots 112 are open. Limit columns 520 for being inserted into the first assembly slots 112 are symmetrically arranged on opposite sides of the rotating portion 530. When the swing column 500 is assembled, the limit columns 520 of the swing column 500 are inserted into the first assembly slots 112 respectively, the swing column 500 is then squeezed downwards to push the rotating portion 530 into the swing cavity A and the insertion bar 510 into the swing hole 320 of the driving disk 300.

Referring to FIG. 5 and FIG. 6, it should be understood that, in the embodiment where the base 100 comprises the first portion 110 and the second portion 120 which are detachable from each other, the first assembly slots 112 are formed in the first portion 110, and the width of the first assembly slots 112 matches the diameter of the limit columns 520, and after the swing column 500 is assembled, large gaps are reserved between the limit columns 520 and the bottoms of the first assembly slots 112. In this way, the rotating portion 530 can be guided when assembled, and omni-directional rotation of the swing column 500 will not be affected.

Referring to FIG. 5 and FIG. 6, in a further embodiment, second assembly slots 113 and first assembly holes 114 are formed in the base 100; similarly, in the embodiment where the base 100 comprises the first portion 110 and the second portion 120 which are detachable from each other, the second assembly slots 113 and the first assembly holes 114 are formed in the first portion 110.

Specifically, the second assembly slots 113 extend in the axial direction, tops of the second assembly slots 113 are open, and the first assembly holes 114 are formed in bottoms of the second assembly slots 113; correspondingly, rotating posts 410 are arranged on two sides of the bottom of the clamping piece 400, and the rotating posts 410 are able to slide along the second assembly slots 113 to be inserted into the first assembly holes 114. When the clamping piece 400 is assembled, the rotating posts 410 can be guided by the second assembly slots 113 to slide to the bottoms of the second assembly slots 113 and then be inserted into the first assembly holes 114, such that the clamping piece 400 can be assembled easily and quickly and does not fall easily in use.

The above embodiments are merely preferred ones of the application, and are not intended to limit the application. Any amendments, equivalent substitutions and improvements made based on the spirit and principle of the application should fall within the protection scope of the application.

What is claimed is:

1. A massager driving assembly, comprising:
a base defining an axis;
a rotating motor fixedly arranged on the base and having a rotating shaft parallel to the axis of the base; and
a driving disk arranged in the base and fixedly connected to the rotating shaft, a non-circular curved groove which has a closed-ring shape and a swing hole which is arranged eccentrically with respect to the rotating shaft being formed in an end surface of the driving disk;
wherein, a clamping piece capable of swinging back and forth unidirectionally is arranged on the base, a bottom of the clamping piece is slidably inserted into the curved groove, a swing column capable of swinging omni-directionally is arranged on the base, a bottom of the swing column is inserted into the swing hole, and a swing center of the swing column is located on an axis of the rotating shaft; and
when rotating, the driving disk drives the clamping piece to swing unidirectionally and drives the swing column to swing omni-directionally.

2. The massager driving assembly according to claim 1, wherein a vibration motor is arranged at a top end of the swing column.

3. The massager driving assembly according to claim 1, wherein the base, the clamping piece and the swing column are all made of plastic material.

4. The massager driving assembly according to claim 3, wherein two said clamping pieces are symmetrically arranged on the base.

5. The massager driving assembly according to claim 1, wherein a receiving cavity is formed in the base, and the driving disk is arranged in the receiving cavity.

6. The massager driving assembly according to claim 5, wherein the base comprises a first portion and a second portion which are detachable from each other, the receiving cavity is formed between the first portion and the second portion, and the clamping piece and the swing column are arranged on the first portion.

7. The massager driving assembly according to claim 1, wherein the curved groove is elliptic.

8. The massager driving assembly according to claim 1, wherein a swing cavity is formed in the base, the swing column comprises a spherical rotating portion rotatably arranged in the swing cavity and an insertion bar inserted into the swing hole, and a top and a bottom of the swing cavity are open to allow the insertion bar to pass through the swing cavity to be inserted into the swing hole.

9. The massager driving assembly according to claim 8, wherein a plurality of stop blocks are arranged on an inner wall of the swing cavity in a circumferential direction of the swing cavity, arc surfaces are arranged on sides, facing an axis of the swing cavity, of the stop blocks, every two adjacent said stop blocks are arranged alternately in the circumferential direction and are symmetric in an axial direction, and the stop blocks cooperatively form a swing space for preventing the rotating portion from moving in the axial direction.

10. The massager driving assembly according to claim 8, wherein the base defines two first assembly slots which are symmetrically located at opposite sides of the swing cavity, each of the first assembly slots extends in an axial direction of the swing cavity, and tops of the first assembly slots are open; and
limit columns are symmetrically arranged on opposite sides of the rotating portion and inserted into the first assembly slots respectively.

11. The massager driving assembly according to of claim 1, wherein assembly slots and assembly holes are formed in the base, the assembly slots extend in a direction parallel to the axis of the base, tops of the assembly slots are open, and the assembly holes are formed in bottoms of the assembly slots;
rotating posts are arranged on two sides of a bottom of the clamping piece, and the rotating posts are slidable along the assembly slots to be inserted into the assembly holes respectively.

12. A massager, comprising the massager driving assembly according to claim 1, a housing having a top formed with an opening, and an elastic core, wherein the massager driving assembly is arranged in the housing, the core has a U-shaped cross-section parallel to an axial direction thereof and is arranged in the opening of the housing, and the clamping piece and the swing column are configured for driving the core to swing and contract for clamping or expand.
